(19) United States
(12) Patent Application Publication
(10) Pub. No.: US 2009/0200151 A1
(43) Pub. Date: Aug. 13, 2009

(54) Apparatus for Purification of Water

(76) Inventor: Maxwell Edmund Whisson, West Australia (AU)

Correspondence Address: CLARK & BRODY, 1090 VERMONT AVENUE, NW, SUITE 250, WASHINGTON, DC, 20005, US

(21) Appl. No.: 12/224,389

(22) PCT Filed: Feb. 28, 2007
(86) PCT No.: PCT/AU2007/000223

§ 371 Date: Nov. 21, 2008

(30) Foreign Application Priority Data
Feb. 28, 2006 (AU) 2006900987

(51) Int. Cl. C02F 1/14; E04D 13/18; B01D 3/00

(52) U.S. Cl. 202/185.1; 126/621

(57) ABSTRACT

Apparatus for purification or water having an evaporation chamber (3), a roof (5) and a condensation chamber (8) and wind air inlet means (14, 15). The evaporation chamber (3) contains a body of impure water (2) and the roof (5) can transmit solar radiation. The solar radiation heats the impure water, increases evaporation and wind air from the wind air inlet (14, 15) moves the water laden air into the condensation chamber (8) where water condenses.

### FIELD OF THE INVENTION

The present invention relates to an apparatus for the purification of water.

### BACKGROUND OF THE INVENTION

It is an aim of the present invention to provide a means for collecting purified water from impure water such as sea water.

### SUMMARY OF THE INVENTION

In accordance with one aspect of the present invention there is provided an apparatus for purification of water characterised in that the apparatus comprises an evaporation chamber, a roof disposed over the evaporation chamber, a condensation chamber and means for admitting ambient wind air into the evaporation chamber, the evaporation chamber being arranged to contain a body of impure water, the roof being capable of transmitting solar radiation, such that, the solar radiation heats the impure water to increase the evaporation thereof, and the condensation chamber is arranged to receive water laden air from the evaporation chamber as a result of action of the ambient wind and water in the water laden air condenses in the condensation chamber.

It has been found that movement of wind air through the chamber during evaporation increases the rate of evaporation by reducing the possibility of the air becoming saturated with water vapour.

An important aspect of the present invention arises from the fact that air with a high water vapour content has a lower density than dry air. This aids in establishing convection currents of the water vapour containing air which reduces energy required to operate the system.

### BRIEF DESCRIPTION OF THE DRAWINGS

The present invention will now be described, by way of example, with reference to the accompanying drawings, in which:—

FIG. 1-A is a schematic aerial view of an apparatus for purification of water in accordance with the present invention which is especially suitable for sheltered water surfaces such as bays, lakes and coral atolls, the apparatus taking the form of a transparent roof through which is mounted a funnel designed to capture wind air and direct the airflow under the roof to exit through slots into a condensation chamber;

FIG. 1-B is a schematic vertical section of the apparatus of FIG. 1-A showing peripheral floats acting as condensation chambers;

FIG. 2 shows an apparatus for purification of water, in accordance with a second embodiment of the present invention also suitable for floating on sheltered water but adaptable for mounting on land in which movement of water vapour to a condensation chamber is assisted by a centrifugal fan driven by a wind turbine;

FIG. 3 is a plan view and vertical transverse sections AA, BB, CC, DD and EE of an apparatus for purifying water in accordance with a third embodiment of the present invention which is similar in function to that shown in FIGS. 1-A and 1-B, but in which a transparent roof takes the form of a transparent funnel mounted on lateral floats;

FIG. 4 is a vertical longitudinal sectional view of an apparatus for purifying water in accordance with a fourth embodiment of the present invention in which a transparent cover is sited above a seawater surface and showing how the covered space may be continued as a duct on land leading up to an elevated condensation chamber;

FIG. 5 is a vertical section of an apparatus for purifying water in accordance with a fifth embodiment of the present invention in which a funnel and attached terminal condensation chamber are held aloft by a lighter than air annular balloon or other suitable support, and air heated by solar radiation and containing water evaporated from an underlying seawater surface or from a pond of impure water, rising by convection to enter the condensation chamber;

FIG. 6 shows an apparatus for purifying water in accordance with the present invention according to a sixth embodiment of the present invention suitable for installing on a coastal area with a tidal estuary which can assist inflow of seawater to large evaporation ponds adjacent to elevated land up which water vapour can rise by convection; and

FIG. 7 is a schematic vertical section of a lower part of an apparatus for purifying water in accordance with the present invention according to a seventh embodiment in which ducting of water vapour and arrangement of water condensation may take a form similar to those described in the preceding figures but is most applicable for application of the apparatus adjacent to an escarpment as described in FIG. 4.

### DETAILED DESCRIPTION

In the accompanying drawings the same reference numerals are used to refer to similar components of the apparatus of the present invention in its various embodiments.

Further, in the descriptions that follow it is to be understood that the present invention, whilst it is applicable to sea water, is also applicable to any large accumulation of impure water.

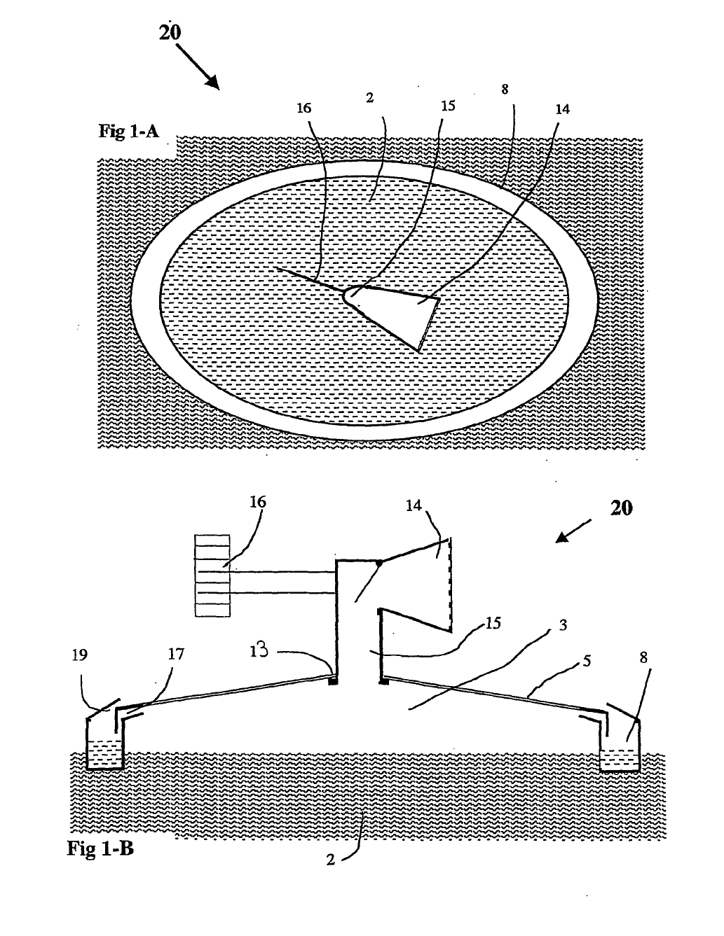

FIG. 1-A of the accompanying drawings shows an apparatus 20 in accordance with the present invention in which a condensation chamber 8 is shown floating on sheltered seawater 2. The condensation chamber 8 takes the form of a gutter or tube provided with ports as described further in FIG. 1-B. The gutter extends around the periphery of a roof 5 also described in relation to FIG. 1-B. At least one wind funnel 14 is provided. The wind funnel 14 has a substantially vertical duct 15 and is mounted at a high point on the roof 5 such that wind entering the funnel 14 is directed into an evaporation chamber 3 defined by the roof 5 and the gutter 8. The wind air passes from the evaporation chamber 3 through the condensation chamber 8 to the outside air.

As shown in FIG. 1-B the roof 5 is preferably formed of a double layer of material such as transparent plastics material or glass, supported as necessary by a frame of metal, plastic, wood or other strong material. The upper part of the roof 5 has at least one opening sealingly fixed through a bearing 13 with a vertical axis to the duct 15 of the wind funnel 14. The wind funnel 14 carries a wind vane 16. The bearing 13 may be mounted on roof struts or joists or on a solid frame fixed to the underwater floor of the seawater 2 as desired but an adequate opening between the wind funnel 14 and the evaporation chamber 3 is important. With either form of mounting, the duct 15 is open to the evaporation chamber 3 but may if preferred be fitted with a flap which is biased by a weight or elastic means to close the opening of the duct 15 to the evaporation chamber 3 such that the flap is readily opened by a small excess of pressure in the duct 15 over the pressure in the evaporation chamber 3, the effect of a light wind entering the funnel being sufficient to open the flap. A lower part of the condensation chamber 8 may be constructed of any corrosion resistant sheet material with good thermal conductivity and be waterproofed so that it can retain purified water and float on the seawater 2 if preferred.

An upper part of the condensation chamber 8 has inward ports 17 allowing entry of air from the evaporation chamber 3. The upper part of the condensation chamber 8 has outward ports 19 allowing the exit of air to the outside. The ports 17 and 19 are shown in the same section in FIG. 1B but are preferably sited at alternating points around the upper part of the condensation chamber 8. The ports 17 preferably have a higher resistance to air flow than the duct 15 of the funnel 14.

In operation, wind blowing into the evaporation chamber 3 picks up water evaporating from the seawater 2 heated by solar radiation falling on and passing through the roof 5. The pressure of the air falls as it passes through the resistance of the ports 17 and also loses heat through the walls of the condensation chamber 8 at the base of the periphery of the apparatus 20. The result is that the dew point of the air falls and condensation occurs on walls of the condensation chamber 8, the condensed water than draining into the lower part of the condensation chamber 8. After giving up water in this way the air discharges to the outside through the ports 19, these openings to the outside air being of adequate dimensions to ensure that the pressure in the condensation chamber 8 is not significantly higher than ambient air pressure even when strong wind is entrained by the funnel 14.

The surface of the seawater 2 enclosed by the evaporation chamber 3 and the roof 5 is preferably covered by black plastic mesh or floating particles, for example of low density polyethylene, the effect of which is to increase absorption of solar radiation transmitted through the roof 5 and so to increase the rate of evaporation of seawater 2 and also to increase the temperature of the water vapour beneath the roof 5. This increases the water content of the air in the evaporation chamber 3. Purified water collecting in the condensation chamber 8 is piped to a suitable holding tank or distribution system as desired. Rain falling on the roof 5 may be collected via the ports 19 and added to the purified water collected in the condensation chamber 8. For some applications a filter means may be fitted in the ports 19 but such a filter must offer only a low resistance to air flow.

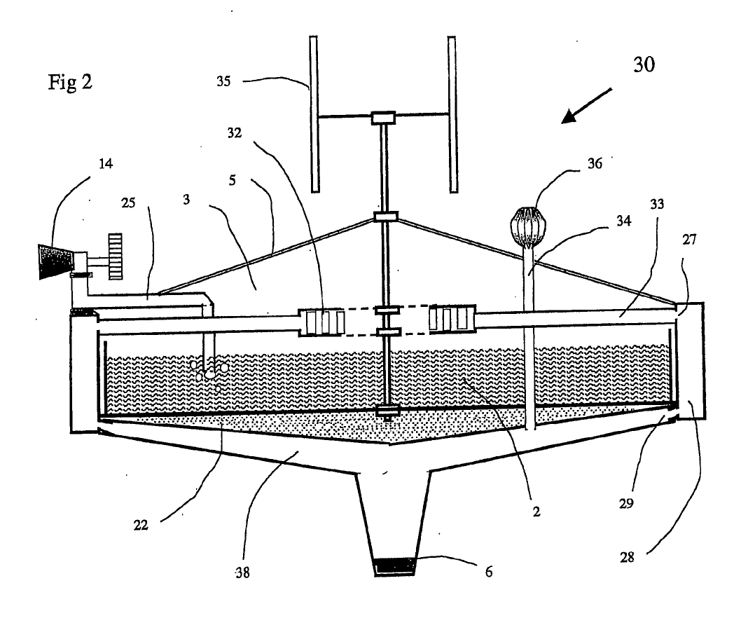

The embodiment 30 of the apparatus of the present invention shown in FIG. 2 is suitable for construction as a unit which floats so that seawater 2 may exchange with seawater at large through ports not shown in the figure. Alternatively, the apparatus 30 may be built on land and seawater 2 would then be delivered to the system by solar heated pipes. A transparent roof 5 covers an evaporation chamber 3 located above the surface of seawater 2.

In the form of the embodiment 30 of the present invention arranged for construction on dry land seawater 2 flows in a channel with a strong waterproof base 22 and with rigid sidewalls during purification. The sea water eventually returns to the sea or a mineral processing plant after concentration by evaporation.

In the form of the embodiment 30 of the present invention arranged to float on an area of sheltered seawater the channel takes the form of a framework allowing exchange of seawater with the open sea and side walls are only required for reasons of robustness.

A fan 32, preferably of centrifugal type is driven by a wind turbine 35, here shown as of the Darrieus type with a vertical shaft mounted on the base 22 and driving the fan 32. Air in the evaporation chamber 3 may enter the fan 32 and be driven out through ducts 33. The ducts 33 may be numerous but leave as much access as practical for solar radiation passing through the roof 3 to reach the seawater 2.

Where it is desired to form an elongated apparatus longitudinal manifolds and a plurality of wind turbines 35 may be desirable.

When wind is turning the wind turbine 35, air passing centrifugally through the ducts 33 is at increased pressure due to the operation of the wind turbine 35, and when sun is shining the ducts 33 will absorb some of the solar radiation so adding to the heat of the vapour-laden air in the ducts 33. The air driven outward by the wind turbine 35 passes from the ducts 33 through apertures 27 into primary condensation chambers 28 which enclose the seawater 2 and, in the form of the invention arranged to float on seawater, are cooled by exposure to the open sea.

In land based arrangements of the apparatus 30 the condensation chambers 28 are cooled by exposure to the open air. Water vapour laden air, after condensation of some of the water, depending on prevailing weather conditions, passes out of the condensation chambers 28 through ports 29 of restricted dimensions into a secondary evaporation chamber 38. Again, as in the case of the primary evaporation chamber 3, cooling may be by exposure to the open sea or to the open air, depending on whether the apparatus 30 is constructed on land or on seawater.

Here it is appropriate to state that an intermediate adaptation of the apparatus 30 may be preferred in which the condensation chambers 28 are elongated to carry water vapour laden air to a site on land where the secondary condensation chamber 38 is constructed, preferably on an elevated site.

Whichever form of secondary condensation chamber 38 is preferred an air exit 34 is fitted and this preferably has a wind-driven exhaust fan 36 fitted at a top thereof to help to maintain air pressure as low as practicable. The air exit 34 is preferably of considerable length and cooled by exposure to the open air and by being first directed through the seawater 2 so that some of the water vapour which has not been condensed in the condensation chambers 28 may condense and drain down into the condensation chamber 38.

Water condensing in and draining into the evaporation chamber 3 then drains into a purified water channel 6 to be distributed by suitable pumps and pipes to storage tanks and to areas of need as desired. Air may enter the evaporation chamber 3 through peripheral flaps arranged to open inward when acted on by wind approaching approximately perpendicularly from outside or, as shown in FIG. 2, air may be entrained by one or more funnels 14. In a preferred form of the apparatus 30 air entering through the funnel 14 is directed through downwardly directed ducts 25 opening a little below the surface of the seawater 2, so forming bubbles which increase the surface area for evaporation. In a preferred form of the apparatus 30 black plastic mesh or spheres are arranged to float on the surface of the seawater 2 so increasing the absorption of solar radiation during the daytime.

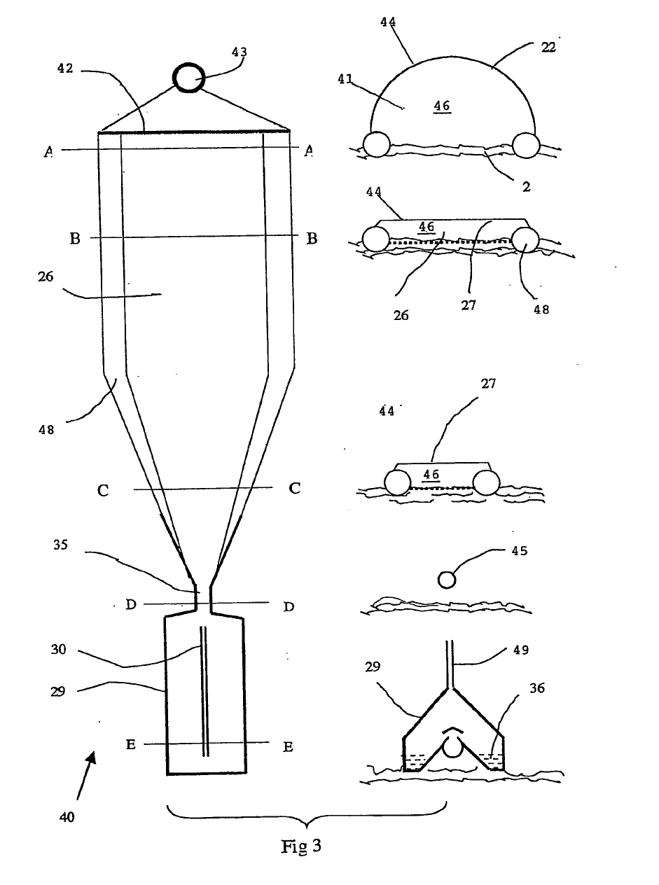

FIG. 3 shows an alternative form of apparatus 40 of the present invention which is a tapered tubular structure 42 floating on lateral floats 48 attached to a mooring 43 about which the structure 42 may feather into the wind so that a funnel shaped opening 41 (see section A-A) may capture the wind. The funnel shaped opening 41 is preferably kept open by a curved rib assisted by attachment to a high point on the mooring 43. This upper mooring link preferably takes the form of a sheet sloping down to the funnel shaped opening 41, so having the effect of increasing the intake of wind into the funnel shaped opening 41. A transparent cover 44 is fixed at sides thereof to upper surfaces of the lateral floats 48 and is held above the surface of the seawater 2 either by its rigidity, if for example it is constructed of corrugated polycarbonate or, if the construction is of flexible material such as polyethylene, by ribs resting on the floats 48. This arrangement forms an evaporation chamber 46 enclosed at the sides by the floats 48, at the bottom by the surface of the seawater 2 and at the top and sides by the transparent cover 44. As in the embodiments shown in FIGS. 1-A, 1-B and 2 there may be a significant advantage in placing a black heat absorbing mesh close to the surface of the seawater 2.

The wide funnel opening 41 is shown in transverse section adjacent to line A-A. The transverse sectional area of the evaporation chamber 46 diminishes as distance from the funnel shaped opening 41 increases. This is illustrated in transverse sectional drawings adjacent to lines B-B and C-C. The funnel shaped opening 41 narrows down to a tube 45 which is of relatively small sectional area as shown in transverse vertical section adjacent to line D-D. The tube 45 is preferably constructed of material of high thermal conductivity to increase the rate of dumping of heat due to conversion of some of the momentum of wind blowing in through the funnel shaped opening 41 into heat energy. Air with increased absolute humidity due to passage over the seawater 2 as it passes under the transparent cover 44 can pass through the tube 45 into a condensation chamber 29 in which the air can expand rapidly with resultant fall in temperature and thus condensation of water. The condensed water can collect on inner walls of the condensation chamber 29 and on walls of an air exit slot 49 opening through the roof of the condensation chamber 29. The walls of the condensation chamber 29 and the slot 49 are preferably constructed from sheet metal and the whole chamber in this preferred form of the present invention can conveniently float on the surface of seawater 2. The tube 45, the condensation chamber 29 and the slot 49 are preferably fitted with ribs or fins to increase their surface area in such a way that rate of loss of heat to the ambient environment is increased. Similarly, shades are preferably fitted above these structures to reduce the amount of solar radiation reaching them.

Distilled or purified water is channeled by appropriate pipes and pumps to the area of need. In one preferred arrangement distilled water is pumped back to a holding tank mounted on top of the mooring 43, which in this arrangement takes the form of a substantial pylon mounted on the sea floor. Further optional preferred refinements of the apparatus 40 are a small wind turbine powered compressor fitted to the top of the tube 45 and operating a fan which accelerates the entry of air from the evaporation chamber 46 through into the tube 45 and the same or a second wind turbine turning a fan arranged to accelerate the exit of air through the slot the 49 and tending to lower air pressure in the condensation chamber 29 when wind is blowing.

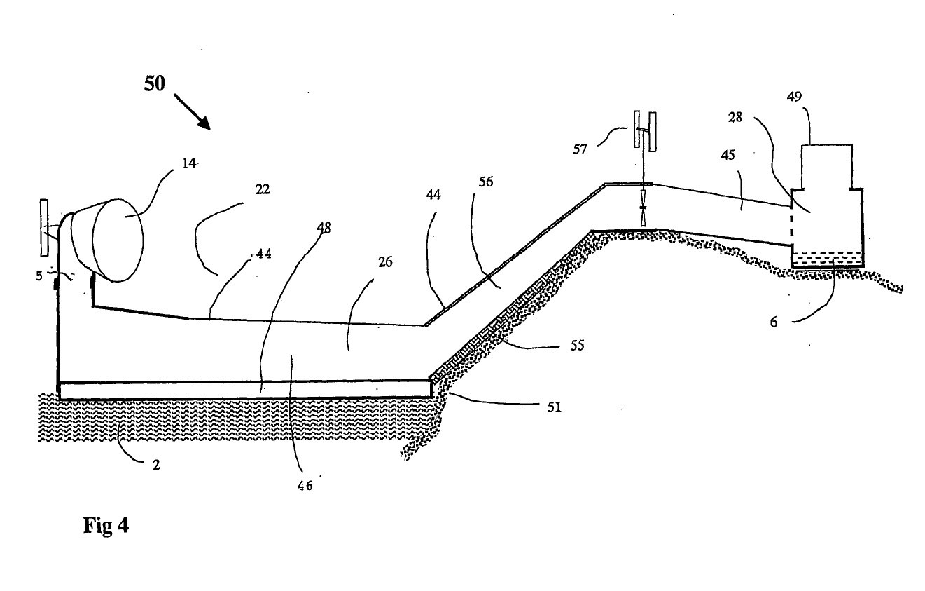

FIG. 4 shows an apparatus 50 generally similar to that illustrated in FIG. 3 but in this preferred form of the present invention the evaporation chamber 46 is extended over a shoreline 51 onto land to form a convection duct 56 with a solid base 55. A transparent roof 44 is supported on floats 48 or alternatively, depending on local conditions, on lateral tubes mounted by pylons on the sea floor. A wind funnel 14 is shown opening through a duct pipe 15 to an evaporation chamber 46 similar to the arrangement shown in FIGS. 1-A and 1-B. However, if preferred, again depending on local conditions, a peripheral wall may be mounted on the floats 48 or on the sea floor and supporting the evaporation chamber cover 44. In such an arrangement a preferred form of the apparatus 50 is to form the evaporation chamber 46 as a wide space similar to that shown in FIGS. 1A and 1B. Preferably, wind is then captured by flaps which are closed at rest but which are easily blown inward to allow the entry of wind into the evaporation chamber 46.

The base 55 of the convection duct 56 is preferably on rising land and constructed of material with a high heat capacity, the temperature of which can exceed ambient temperature due to the absorption of solar radiation passing through the roof 44 during daylight hours so helping to maintain an elevated temperature in the water vapour passing through it. The momentum of water vapour moving upward driven by wind entrained into the evaporation chamber 46 and by convection through the convection duct 56 results in an increase in pressure close to the outlet from a tube 45, which offers a high resistance to flow due to the relatively small cross sectional area of the openings into a condensation chamber 28. If preferred, resistance to the flow of the vapour-laden air may alternatively be made high by the incorporation of an electricity-generating fan in the tube 45. Electricity so generated may assist operation of the apparatus 50 in a number of ways, for example by powering a small conventional phase-change refrigeration system to provide local cold surfaces within the condensation chamber 28, so increasing the condensation rate, by powering control systems such as level meters and flow valves, powering small water pumps and if desired, and for powering an exhaust fan which can if preferred be fitted to the top of a vent 49 to lower the pressure in the condensation chamber 28. On emerging from the tube 45 into the condensation chamber 28 the pressure and thus the temperature of the vapour-laden air falls rapidly resulting in condensation of water vapour which collects off walls of the condensation chamber 28 and inner walls of the vent 49 above it. Purified or potable water collecting in the condensation chamber 28 may be piped to holding tanks and distribution systems by conventional means. A further desirable but optional refinement of this form of the apparatus 50 is the incorporation of a wind turbine 57 driving a compressor fan fitted in the tube 45 in such a way that wind acting on the wind turbine 57 increases the pressure of the vapour-laden air entering the tube 45.

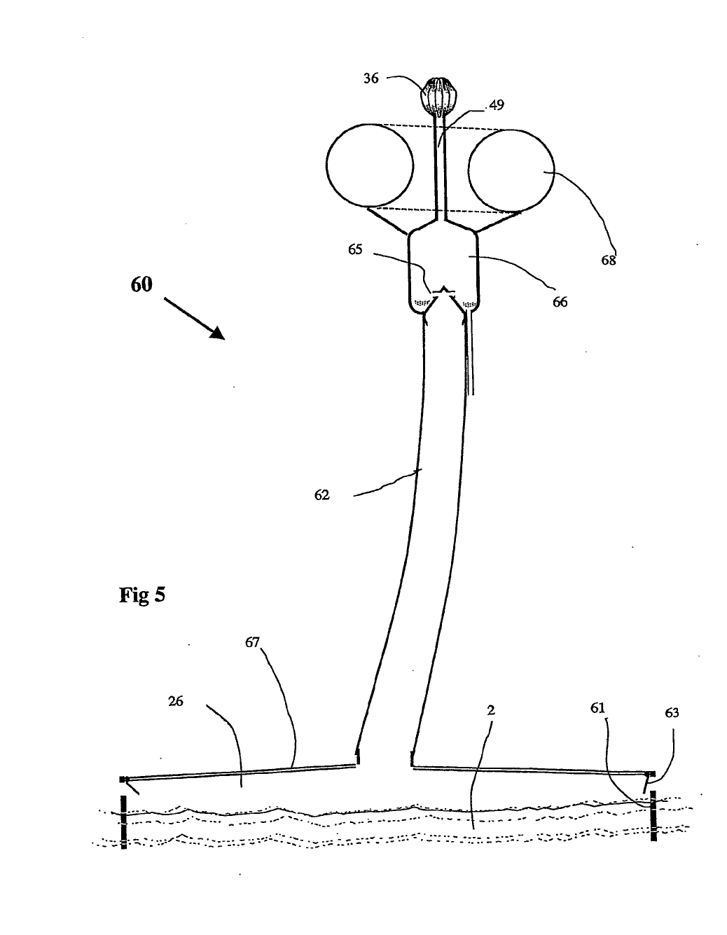

FIG. 5 shows a further preferred alternative embodiment of an apparatus 60 according to the present invention. This is similar in principle to the form of the invention shown in FIG. 4, but in this embodiment convection due to the lower density of wet air is expected to play a larger part in moving the water vapour upward through a water vapour channel 62 than incident wind. A transparent cover 67 is mounted a short distance above the surface of sheltered seawater 2, with the periphery of the covered air substantially open to the outside air through inwardly opening flaps 63. The mounting may be on moored floats or on pylons fixed to the sea floor as preferred or on land. However, an alternative preferred embodiment seawater carried from a suitable source may be carried by solar heated pipes to a flat pond on land. In this alternative form of the invention the transparent cover 67 may be mounted on peripheral walls with openings 63 allowing the entry of incident wind.

The transparent cover 67 is approximately dome shaped or conical and may be formed of rigid transparent plastics material such as corrugated polycarbonate or formed of flexible transparent plastics material.

In either case the cover 67 is supported by suitable rigid supporting struts, girders and columns as required. These structures must offer minimal interference with the incidence of solar radiation onto the surface of the seawater 2. A water vapour channel 62 opens upwardly from a high point on the transparent cover 67. The water vapour channel 62 may be rigid and supported by a suitable framework fixed to the roof and, if desired, to the sea floor.

In an alternative construction at least the upper part of the water vapour channel 62 may be constructed of flexible material held open with an approximately circular cross section by circular lighter than air battens or toroidal circumferential balloons filled with a gas such as helium which is lighter than air. The water vapour channel 62 opens to a condensation chamber 66 above it through an opening 65 of restricted cross sectional area so providing a pressure drop as water vapour laden air passes from the water vapour channel 62 up into the condensation chamber 66. The restriction to flow may if preferred be increased by the incorporation of an electricity generating fan in the opening 65. The electricity generating fan may have refrigerated blades. Water vapour passing into the condensation chamber 66 undergoes a rapid fall in pressure and temperature, with the result that water condenses on walls of condensation chamber 66 and on inner surfaces of an upwardly opening vent 49 which may be fitted with an exhaust fan 36 to help maintain a low pressure in the condensation chamber 66. An opening or openings in the floor of the condensation chamber 66 are sealingly attached to appropriate pipes allowing distilled water to drain downwards to a suitable tank and distribution system. An advantage of mounting at least the lower part of water vapour channel 62 on a rigid framework is that such a framework can also be used to mount a distilled water tank well above sea level.

A lighter than air balloon 68 may if preferred be attached to the condensation chamber 66 to help maintain the upward orientation of the vapour channel 62.

In operation, the area between the surface of the seawater 2 and the transparent roof 67 acts as an evaporation chamber 26. The effectiveness of this may be increased by a layer of black beads or mesh floating or suspended near the seawater surface. In addition, it may be preferred in some environments to form at least part of roof 67 of opaque black material, preferably with radial downwardly directed ribs, solar heat then being transferred to the seawater surface and to the air from the hot roof. Air heated by the warmed sea surface rises by convection in the channel 62 and its upward momentum is partly converted to pressure energy near the top, with the loss of some heat through walls of the channel 62.

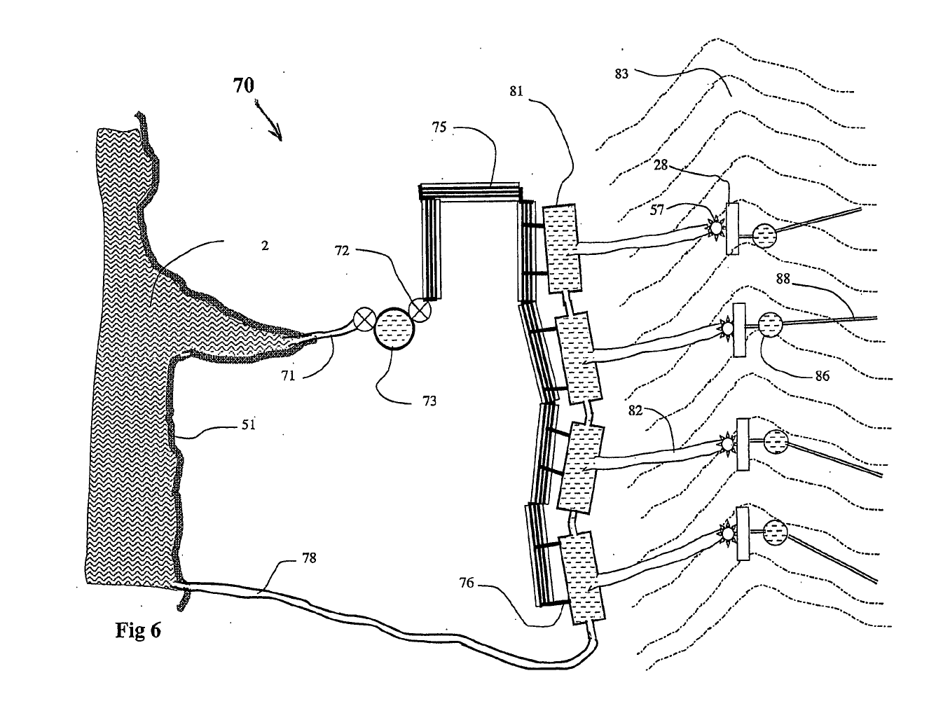

FIG. 6 shows an apparatus 70 in accordance with the present invention suitable for installing on a coastal area with a tidal estuary which can assist the inflow of seawater to large evaporation ponds adjacent to elevated land up which water vapour can rise by convection from ducts in roofs of the evaporation ponds to hilltop condensation chambers. The coastline 51 is selected as having an estuary having a tapering shape which results in a high tide at the apex. Alternatively, such a tapering estuary may be formed by sea walls and excavation. A channel or pipe carries the tidal flow of seawater 2 into a holding reservoir 73 from which it flows at a rate controlled by valves and pumps 72 as required through a solar heated pipeline 75 to shallow evaporating ponds 81. The pipeline 75 preferably has a large black surface such as may be formed by parallel black metal pipes or a shallow channel with a rough black floor and may be covered by a transparent heat insulating cover such as a double layer of Perspex or polycarbonate sheet. Seawater passing through the pipeline 75 thus reaches the evaporating ponds 81 at elevated temperature.

In FIG. 6 the evaporation ponds 81 are shown connected in series by pipes but a preferred arrangement is that the pipeline 75 runs adjacent to the evaporation ponds 81 and feeds them with solar heated seawater through control valves as necessary to maintain a shallow layer of seawater in the ponds.

Evaporation ponds 81 have a heat insulating transparent cover similar to that shown in FIG. 5 and one or more convection ducts 62 opening from an apex or high point in a transparent cover. Floors of the evaporation ponds 81 are preferably constructed of strong material such as reinforced concrete with a rough black surface to maximize absorption of solar energy. The evaporation ponds 81 are preferably sited on low land at the foot of a ridge 83 such as a sand dune or coastal escarpment. The ducts 62 are insulated against heat loss but preferably have a double layered transparent roof and black radiation absorbent floor similar to the convection duct 56 in FIG. 4. Other features of the apparatus 70 are also similar to the apparatus 50 shown in FIG. 4, the ducts 62 being arranged to carry water vapour up to condensation chambers 28 preferably sited on an elevated site such as the ridge 83. The evaporation ponds 81 have openings arranged to collect wind air such as funnels or inwardly opening flaps easily blown inward by wind or by a relatively low pressure in the evaporation chambers between the seawater in evaporation ponds 81 and the transparent cover. Air with a high water vapour content will rise by convection in the ducts 62 assisted by any wind blowing into the evaporation chamber, but may be further assisted by wind turbines 57 coupled to compressor fans arranged to assist the entry of the water vapour-laden air into the condensation chambers 28 through restricted openings or through an electricity generating fan. Tanks 86 as shown in FIG. 6 provide storage of purified water which can conveniently be distributed to areas of need by pipes 88. Seawater concentrated by evaporation is returned to the sea by a pipe 78, assisted by pumps and valves as required or preferably by timed valves which allow flow at low tide.

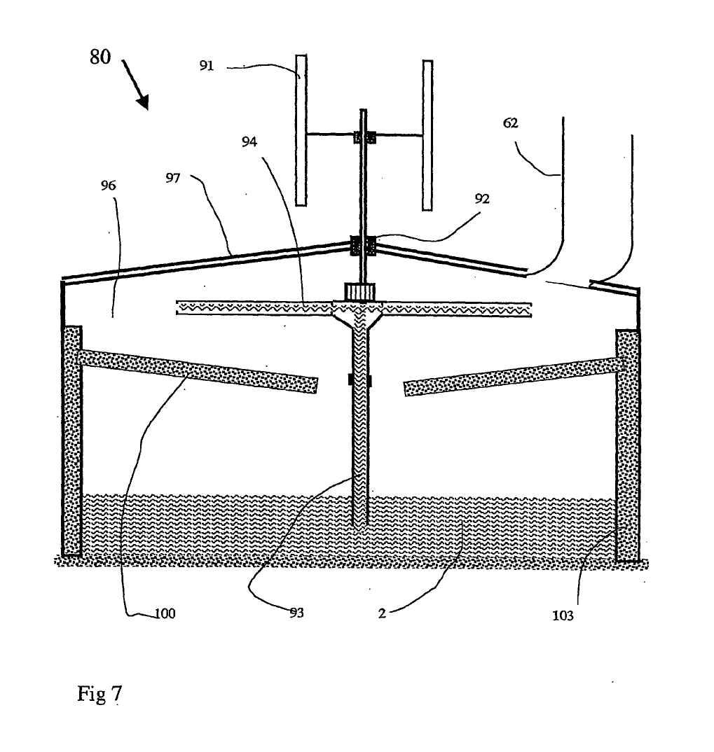

FIG. 7 shows an apparatus 80 in accordance with a further embodiment of the present invention. The arrangement of water vapour transport and condensation in this form of the invention can be similar to any one or more arrangements described hereinbefore but is particularly suitable for combination with the concepts described in FIGS. 4, 5 and 6. In FIG. 7 a wind turbine 91 preferably acting through a gearbox 92 turns a vertical pipe 93 on an approximately vertical axis. The pipe 93 opens below into seawater 2. At a top end the pipe 93 opens to one or more radial pipes 94 which are preferably balanced about a vertical axis of rotation. The pipes 94 open at outer ends thereof into an evaporation chamber 96 so that when turned at high speed by the wind turbine 91, seawater is ejected from the outer ends of pipes 94 by centrifugal force and sucked up from the seawater 2 through the pipe 93. Since the pipes 94 are turning the seawater ejected from their ends will emerge as a finely divided spray. The evaporation chamber 96 preferably has a much larger diameter than pipes 94 and has a transparent cover 97 through which solar radiation can heat the emerging seawater spray, the pipes 94 and a floor 100 of the evaporation chamber 96.

Outwardly sloping reflecting surfaces can be mounted on outer walls 103 to increase the collection of solar energy if desired. The walls 103 are mounted on the sea floor or on the floor of a pond or channel containing seawater as shown for example in FIG. 6 and as appropriate to the conditions and application of the apparatus 80. The floor 100 of the apparatus 80 is partly open to allow drainage of unevaporated seawater to the sea below and to allow air to rise up into the evaporation chamber 96. Air entering the evaporation chamber 96 is able to exit through a hole in evaporation chamber roof 67 to which is fixed a water vapour channel 62. Preferably, the lower end of the water vapour channel 62 is fitted through evaporation chamber roof 67 at an angle approximately tangential to the circle traced by the tips of pipes 94 and approximately in the direction of rotation of the tips but also with an outwardly directed radial component.

In this way air is driven by the rotating pipes 94 acting like a centrifugal fan into the water vapour channel 62. The upward movement of water vapour up through water vapour channel 62 is further accelerated by the lower density of wet air and by suction created by a fan preferably driven by a wind turbine acting to force water vapour into a condensation chamber as shown in FIG. 4. Alternatively the compression and water vapour condensation arrangements shown in FIG. 5 may be fitted to this embodiment of the invention.

In operation of the apparatus of the present invention a major source of heat is the heat of condensation. This heat must be lost from the walls and any of the condensation surfaces in the condensation chamber. Thus, heat must be allowed to pas into the ambient environment such as air or sea water or the ground on which the apparatus is standing on.

The heat loss may be accelerated by wind air by lower air temperature occurring at elevated sites. In other cases impure water acts as a heat sink at ambient temperature into which heat from solar heater water vapour can pass.

Modifications and variations of the present invention such as would be apparent to a skilled addressee are deemed to be within the scope of the present invention.

1-16. (canceled)

17. An apparatus for purification of water characterized in that the apparatus comprises an evaporation chamber, a roof disposed over the evaporation chamber, a condensation chamber and means for admitting ambient wind air into the evaporation chamber, the evaporation chamber being arranged to contain a body of impure water, the roof being capable of transmitting solar radiation, such that, the solar radiation heats the impure water to increase the evaporation thereof, and the condensation chamber is arranged to receive water laden air from the evaporation chamber as a result of action of the ambient wind and water in the water laden air condensing in the condensation chamber, wherein the evaporation chamber is arranged to be extended over a shoreline onto land to form a convection duct, the convection duct being arranged to be disposed on upwardly sloping land so that water laden air from the evaporation chamber rises upwardly by convection, the convection duct leading to a constricted region which in turn leads into the condensation chamber in which air can expand and from which water can condense.

18. An apparatus according to claim 17, characterized in that the apparatus is arranged to float on impure water.

19. An apparatus according to claim 17, characterized in that the roof has mounted thereon a wind funnel arranged to direct wind air into the evaporation chamber.

20. An apparatus according to claim 18, characterized in that the roof has mounted thereon a wind funnel arranged to direct wind air into the evaporation chamber.

21. An apparatus according to claim 17, characterized in that the convection duct comprises a fan driven by a wind turbine wherein water laden air in the evaporation chamber enters the convection duct and is driven towards the condensation chamber by the fan.

22. An apparatus according to claim 18, characterized in that the convection duct comprises a fan driven by a wind turbine wherein water laden air in the evaporation chamber enters the convection duct and is driven towards the condensation chamber by the fan.

23. An apparatus according to claim 19, characterized in that the convection duct comprises a fan driven by a wind turbine wherein water laden air in the evaporation chamber enters the convection duct and is driven towards the condensation chamber by the fan.

24. An apparatus according to claim 20, characterized in that the convection duct comprises a fan driven by a wind turbine wherein water laden air in the evaporation chamber enters the convection duct and is driven towards the condensation chamber by the fan.

25. An apparatus according to claim 21, characterized in the means is provided for exhausting air from the condensation chamber.

26. An apparatus according to claim 17, characterized in that the condensation chamber or adjacent structures allow heat to pass out into the ambient environment.

27. An apparatus according to claim 18, characterized in that the condensation chamber or adjacent structures allow heat to pass out into the ambient environment.

28. An apparatus according to claim 19, characterized in that the condensation chamber or adjacent structures allow heat to pass out into the ambient environment.

29. An apparatus according to claim 20, characterized in that the condensation chamber or adjacent structures allow heat to pass out into the ambient environment.

30. An apparatus according to claim 21, characterized in that the condensation chamber or adjacent structures allow heat to pass out into the ambient environment.

31. An apparatus according to claim 22, characterized in that the condensation chamber or adjacent structures allow heat to pass out into the ambient environment.

32. An apparatus according to claim 23, characterized in that the condensation chamber or adjacent structures allow heat to pass out into the ambient environment.

33. An apparatus according to claim 24, characterized in that the condensation chamber or adjacent structures allow heat to pass out into the ambient environment.

34. An apparatus according to claim 25, characterized in that the condensation chamber or adjacent structures allow heat to pass out into the ambient environment.

35. An apparatus according to claim 26, characterized in that the ambient environment is air or impure water or ground on which the apparatus stands.
